(19) United States
(12) Patent Application Publication
(10) Pub. No.: US 2012/0210244 A1
(43) Pub. Date: Aug. 16, 2012

(54) Cross-Domain Privacy Management Service For Social Networking Sites

(75) Inventors: José de Francisco Lopez, Aurora, IL (US); David S. Benco, Winfield, IL (US)

(73) Assignee: Alcatel-Lucent USA Inc., Murray Hill, NJ (US)

(21) Appl. No.: 13/025,030

(22) Filed: Feb. 10, 2011

(51) Int. Cl. G06F 15/16; G06F 3/01; G06F 21/00

(52) U.S. Cl. 715/747; 709/204; 726/26

(57) ABSTRACT

A cross-domain privacy management service for social networking sites is implemented in a communication system including a user platform operably connected to an application platform. The application platform accesses one or more social networking sites on behalf of a user to obtain indicia of privacy settings of the user and displays the privacy settings via a graphical user interface accessible to the user independent of the social networking sites. The user may interact with graphical icons via the graphical user interface to change privacy settings of one or more impacted sites, and the user changes are communicated to the social networking sites via the application platform on behalf of the user.

### BACKGROUND OF THE INVENTION

1. Field of the Invention

This invention relates generally to communications systems and, more particularly, to communications systems that support social networking sites and services.

2. Statement of the Problem

Social networking sites are well known in which persons may interact with and share media content with other users, friends or the like via a web-based platform. Examples of social networking sites include, for example, Facebook (catering largely to social interaction among friends (and future friends)), LinkedIn (specializing in professional interactions and relationships) and Twitter (specializing in dissemination of short text-based messages), to name a few.

Typically, when a user establishes an account with a social networking site, they create a user profile that contains information about themselves such as, for example and without limitation, name, gender, birth date, hobbies, interests or the like; and social links. The user profile information may be accessible to other users of the social networking site, depending on privacy settings established by the user, or based on default settings. The user might also post content (including, without limitation, text, audio, video or image content) that may be viewed by other users of the social networking site depending on privacy settings. The privacy settings may specify, for example, users or user groups that are authorized (or not authorized) to view certain items of user profile information or content.

Privacy settings are currently managed per individual social networking service, by the user manually logging in with user name and password and selecting menu choices, checking or un-checking boxes, and the like, to achieve the desired level of privacy. This can be a cumbersome and time-consuming process, and can be made even more cumbersome when privacy options or default settings are periodically changed by a social networking site, due for example to new features, updates or the like requiring the user to set or reset various parameters. Further still, it is not uncommon for users actively engaged in the social networking world to have accounts with multiple independent social networking services, having different user interfaces and generally different privacy options, default settings and the like, making the management of one's privacy settings a time-consuming and daunting matter. The net effect is that the privacy of all but the most diligent users can be compromised or even unknown to the user.

### SUMMARY OF THE SOLUTION

This invention solves the above and other problems by providing a cross-domain privacy management service for social networking sites. The cross-domain privacy management service provides a quick and convenient way to manage one's privacy settings corresponding to potentially multiple social networking sites.

In one embodiment, there is provided an apparatus for providing privacy management services associated with one or more social networking sites of a user, in accordance with a communication system including a user platform operably connected to an application platform, the apparatus at the application platform comprising a memory and a processor, the processor configured to access one or more social networking sites of a user; obtain from the one or more social networking sites, indicia of privacy settings of the user corresponding to the respective social networking sites; and display the privacy settings on a graphical user interface accessible to the user independent of the social networking sites. In one embodiment, the processor is further configured to obtain from the user via the graphical user interface, indicia of one or more user changes to the privacy settings, the one or more user changes being associated with the privacy settings of at least one impacted site; and interact with the at least one impacted site on behalf of the user to update the privacy settings.

In another embodiment, there is provided a method for providing privacy management services associated with one or more social networking sites of a user, in accordance with a communication system including a user platform operably connected to an application platform, the method comprising the application platform obtaining from the one or more social networking sites, indicia of privacy settings of the user corresponding to the respective social networking sites; and displaying the privacy settings on a graphical user interface accessible to the user independent of the social networking sites. In one embodiment, the method further comprises obtaining from the user via the graphical user interface, indicia of one or more user changes to the privacy settings, the one or more user changes being associated with the privacy settings of at least one impacted site; and interacting with the at least one impacted site on behalf of the user to update the privacy settings.

In yet another embodiment, there is provided an apparatus for providing privacy management services associated with one or more social networking sites of a user, in accordance with a communication system including a user platform operably connected to an application platform, the apparatus at the user platform comprising a memory, display and at least one processor, the at least one processor configured to obtain from the application platform, indicia of privacy settings of the user corresponding to the respective social networking sites; display the privacy settings to the user via a graphical user interface; receive via the graphical user interface, indicia of one or more user changes to the privacy settings, the one or more user changes being associated with the privacy settings of at least one impacted site; and communicate the user changes to the at least one impacted site via the application platform.

In still another embodiment, there is provided a method for providing privacy management services associated with one or more social networking sites of a user, in accordance with a communication system including a user platform operably connected to an application platform, the method comprising the user platform obtaining from the application platform, indicia of privacy settings of the user corresponding to the respective social networking sites; displaying the privacy settings to the user via a graphical user interface; receiving via the graphical user interface, indicia of one or more user changes to the privacy settings, the one or more user changes being associated with the privacy settings of at least one impacted site; and communicating the user changes to the at least one impacted site via the application platform.

### DESCRIPTION OF THE DRAWINGS

FIG. 1 is a block diagram of a communication system implementing a cross-domain privacy management service according to embodiments of the present invention.

FIG. 2 is a flowchart showing steps associated with a cross-domain privacy management service according to an embodiment of the present invention.

FIG. 3 is a first exemplary display screen of a privacy management portal associated with the cross-domain privacy management service according to an embodiment of the present invention.

FIG. 4 is a second exemplary display screen of a privacy management portal associated with the cross-domain privacy management service according to an embodiment of the present invention.

FIG. 5 is a third exemplary display screen of a privacy management portal associated with the cross-domain privacy management service according to an embodiment of the present invention.

### DETAILED DESCRIPTION OF THE INVENTION

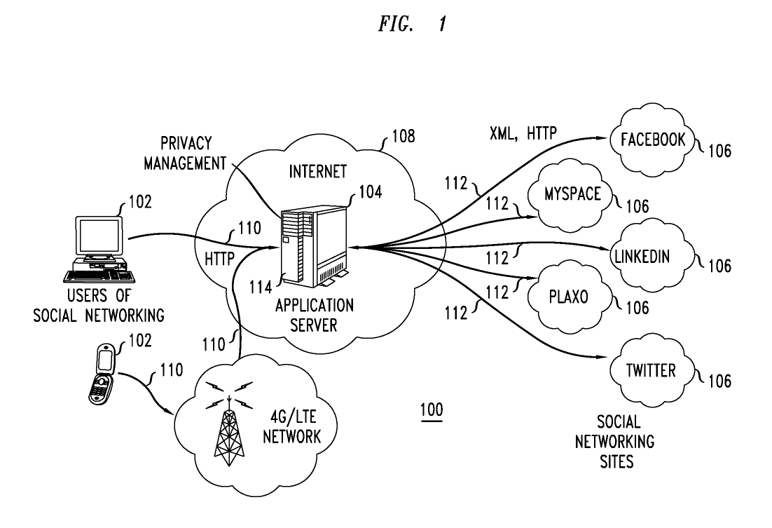

FIG. 1 illustrates a communication system 100 implementing a cross-domain privacy management service according to embodiments of the present invention. The communication system 100 includes one or more user platforms 102 (two shown) interconnected by an application platform 104 to various exemplary social networking sites 106 (as shown, Facebook, MySpace, LinkedIn, Plaxo and Twitter). The user platforms 102 may comprise, for example and without limitation, laptop computers, desktop computers or mobile computing devices, nominally including web browers, and which are subject to operation by users (not shown) that communicate with one or more of the social networking sites 106 via the application platform 104.

In one embodiment, the application platform 104 comprises a computer device, server or software application residing remotely from the user platforms (as shown, residing in the Internet “cloud” 108) that executes an application program to perform a cross-domain privacy management service for users. In effect, the application program comprises a privacy management portal 114 that interfaces users with potentially multiple social networking sites 106 and that facilitates management of the users privacy settings associated with the various sites 106. As will be appreciated, the privacy management portal 114 is a functional element that may be distributed among multiple application platforms 104 and, alternatively or additionally may be distributed at least in part among certain user platforms 102.

The user platforms 102 and application platform 104 each include a processor and memory (not shown) for effecting transactions or segments of transactions associated with user interactions with the privacy management portal. Generally, the processors of the respective platforms are operable to execute program code (e.g., including but not limited to operating system firmware/software and application software) stored in the respective memories, the execution of which depends at least in part from commands issued from the user platforms 102.

The user platforms 102 are connected to the application platform 104 by functional links 110 comprising generally any communication topology suitable for linking the user platforms 102 to the application platform 104. For example and without limitation, link 110 may comprise a wireless link (e.g., as shown, via a 4G/LTE wireless base station) for a mobile computing device and/or a packet-based link (e.g., as shown, implementing an HTTP protocol) for a fixed device such as a laptop computer. The application platform is similarly connected to the social networking sites by functional links 112 (as shown, implementing XML and HTTP protocol).

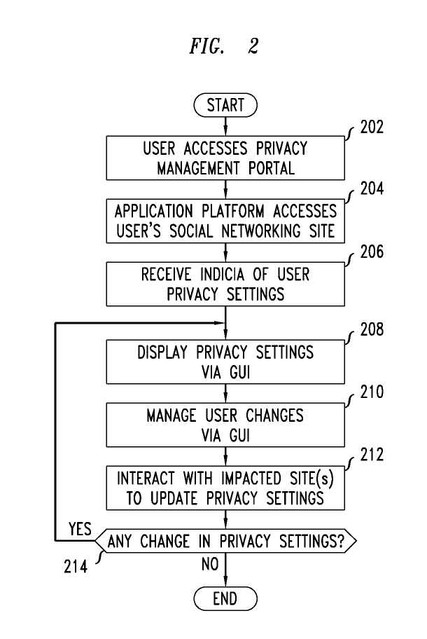

FIG. 2 is a flowchart showing steps associated with a cross-domain privacy management service according to an embodiment of the present invention. The steps of FIG. 2 are performed, where applicable, by the application platform 104 in conjunction with one or more user platforms 102 and/or one or more social networking sites 106 linked to the privacy management portal 114.

At step 202, the user accesses the privacy management portal 114. For example and without limitation, the user might access the privacy management portal via the Internet by entering a URL (Uniform Resource Locator) associated with the privacy management portal in the address line of their web browser or the user may simply click on a URL associated with the file resource if it is specified in a hypertext link. It is contemplated the user may be prompted to enter a user name or account number and optionally, password uniquely associated with the user 102 to access a particular user page or portion of the privacy management portal that contains information or provides services specific to the user account.

If the user is a first-time user of the privacy management portal, it is contemplated that the user may be prompted to create an account, enter user name, password or the like before allowing user access to the privacy management services. In one embodiment, first-time users are also prompted for user names, passwords and the like associated with their social networking sites. The privacy management portal stores this information in memory and retrieves it as needed to access the user's social networking sites on behalf of the user, as will be described in greater detail hereinafter.

At step 204, the application platform (provided it has knowledge of the respective user names, passwords and the like associated with the user's social networking sites) will connect to the respective sites on behalf of the users so as to exchange information with the sites relevant to the privacy settings.

At step 206, the application platform obtains indicia of privacy settings of the user corresponding to the user's social networking sites; and at step 208 it displays the privacy settings to the user (i.e., via a display accessible to the user via the privacy management portal). In one embodiment, the display of privacy settings at step 208 is implemented via a graphical user interface (GUI) comprising various “cells” in a grid arrangement, and through the use of icons representing social networking sites of the user placed within the cells both for reporting the privacy settings and for modifying the privacy settings responsive to user input.

At step 210, the application platform may receive indicia of user changes to the privacy settings via the GUI. In one example and without limitation, the user may drag social networking icons to different cells of the privacy management portal grid in order to modify privacy settings associated with the relevant social networking site(s). Generally, as will be appreciated, user changes may be communicated to the application platform by any mode of user input associated with the GUI.

At step 212, the application platform interacts with any impacted sites to update the privacy settings as needed. That is, the privacy settings are communicated by the application platform to the impacted sites on behalf of the user, so that changes may be implemented by the impacted sites without any direct user interaction.

At step 214, the application platform may also receive changes to user privacy settings initiated by the social networking sites. If any such changes are received, the process return to step 208 and the application platform displays the site-initiated changes on the GUI, thereby enabling affected users to view any site-initiated changes to their privacy settings independent of any direct user interaction with the social networking sites.

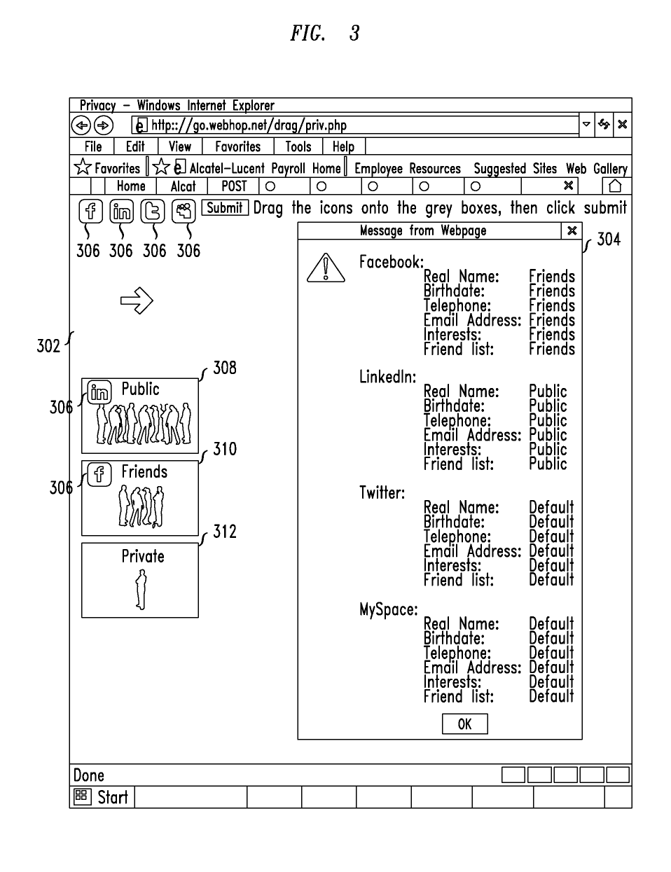

Exemplary display screens of the privacy management portal 114 in a Microsoft Windows-based implementation are shown in FIG. 3 through FIG. 5. Referring initially to FIG. 3, the display includes a primary window 302 and a message pane 304 including indicia of user privacy settings. For convenience, the primary window 302 and message pane 304 are shown simultaneously, however it will be appreciated that the primary window 302 and message pane 304 may be viewed individually depending on user preferences, selections and the like. Near the top of the primary window 302, there is a row of four icons 306 representing a user's social networking sites. As shown, the icons 306 correspond to Facebook, LinkedIn, Twitter and MySpace, respectively. Below the icons 306 there are three cells 308, 310, 312 corresponding to different privacy settings (as shown, “Public,” “Friends” and “Private”). Generally, the “Public” privacy setting indicates content that, if so classified, will be accessible to users in the general public with minimal or no restrictions; the “Friends” privacy setting indicates content that if so classified, will be accessible only to certain users or groups of users that are specified by the user as “friends;” and the “Private” privacy setting indicates content that if so classified, will be inaccessible to other users.

Notice as shown in the exemplary display of FIG. 3, a LinkedIn icon 306 resides within the “Public” cell 308 and a Facebook icon 306 resides within the “Friends” cell 310. In one embodiment, the presence of these icons within respective cells 308, 310 indicates that user profile information associated with the LinkedIn site is accessible to the public; and that user profile information associated with the Facebook site is accessible to designated “friends” of the user. The absence of Twitter and MySpace icons in any of the cells indicates that the privacy settings of those sites are set to default settings associated with those sites. Notice also that the message pane 304 indicates the privacy settings corresponding to particular user profile information (as shown, Real Name, Birthdate, Telephone, Email Address, Interests and Friend List) of the various sites. In particular, the Facebook user profile information is indicated to be at the “Friends” setting, LinkedIn user profile information is at the “Public” setting, and Twitter and MySpace user profile information is at the default settings (not shown in FIG. 3) of the respective sites.

With reference to the steps of FIG. 2, the information displayed in FIG. 3 may have been obtained by the application platform interacting with the respective social networking sites on behalf of the user to receive indicia of the user's privacy settings at step 206, and then displaying the privacy settings within the cells 308, 310 and within the message pane 304. Alternatively, the presence of the LinkedIn and Facebook icons within the cells 308, 310 may be a result of the user dragging the respective icons to the cells in order to change the privacy settings at step 210; the message pane thereby indicating the updated privacy settings confirmed with the site at step 212.

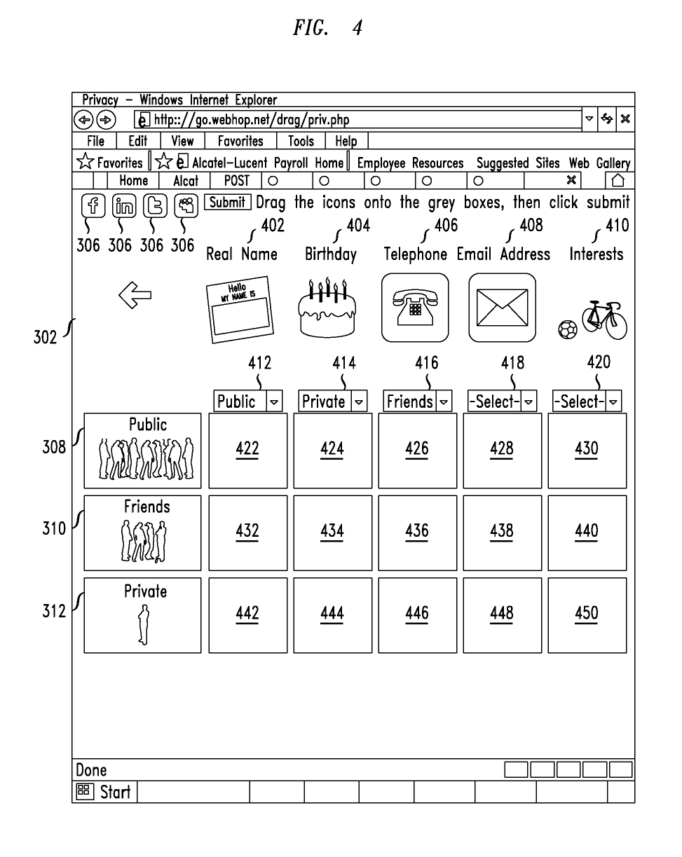

Now turning to FIG. 4, there is shown another exemplary display/GUI (as shown, displayed in the primary window 302 of a Windows-based implementation) of the privacy management portal that may be used to modify the privacy settings responsive to user input. Similarly to the display of FIG. 3, the display includes a row of four icons 306 representing a user's social networking sites, in particular Facebook, LinkedIn, Twitter and MySpace, respectively; and below the icons there are three cells 308, 310, 312 corresponding to different privacy settings “Public,” “Friends” and “Private.”

However, notice in the exemplary display of FIG. 4, the cells 308, 310, 312 correspond to rows of a larger grid arrangement, whereby the grid arrangement is defined by intersection of the rows with columns 402-410 representing various profile categories (as shown, Real Name, Birthdate, Telephone, Email Address and Interests) of the various sites. The grid arrangement includes a plurality of cells 422-450 each corresponding to particular pairings of privacy settings with profile categories; and which may be used to report or modify privacy settings by placing icons 306 of social networking sites within the appropriate cells. For example, the user might change his Facebook “Real Name” profile from “Friends” (as in the display of FIG. 3) to “Public” by dragging the Facebook icon 306 into cell 422. Or the application platform may report that the users Facebook “Real Name” profile is set to “Public” by displaying the Facebook icon 306 in cell 422.

In one embodiment, the columns 402-410 also include respective drop-down menus 412-420 from which the users may select/change privacy settings. As shown, the user has selected the “Public” menu option in the Real Name category via drop-down menu 412, the “Private” menu option in the Birthdate category via drop-down menu 414, and the “Friends” menu option in the Telephone category via drop-down menu 416. In one embodiment, following user selection of a privacy setting in any of the drop-down menus 412-420, that privacy setting is established for the impacted profile category or categories in all of the user's social networking sites except that any particular setting may be overridden by appropriate placement of social networking site icons 306 within one or more of the cells 422-450. In other words, user selection/modification of privacy settings via dragging of the icons 306 into one or more of the cells 422-450 takes precedence over user selection via one or more drop-down menus 412-420 if there is a conflict.

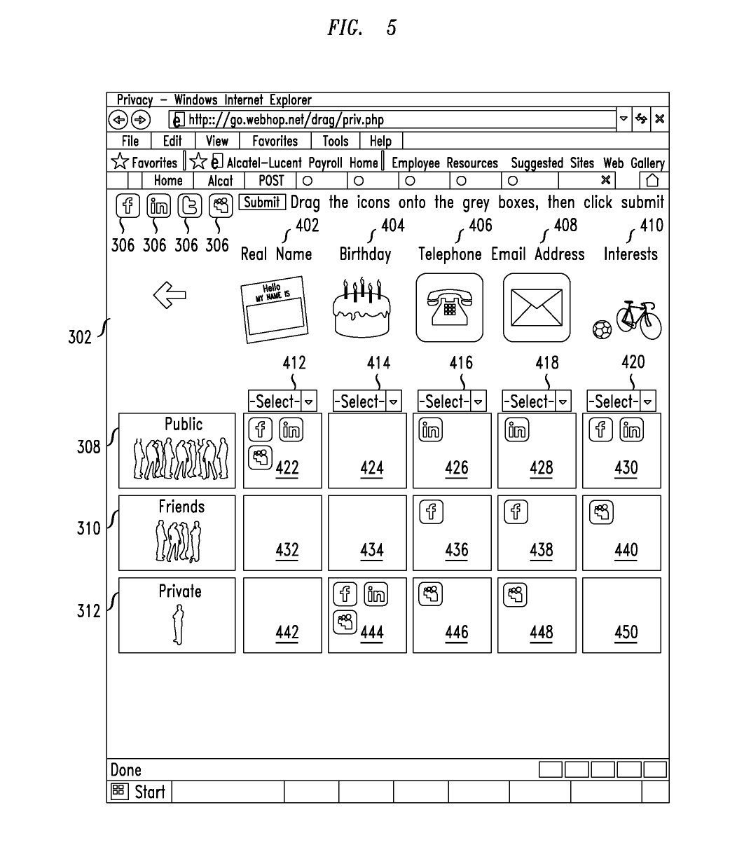

FIG. 5 shows an another exemplary display/GUI in the primary window 302 of the privacy management portal. The display of FIG. 5 comprises the same grid arrangement of FIG. 4, except it shows an example report of privacy settings to the user. In particular, the presence of social networking site icons within the cells 422-450 indicates the present status of privacy settings corresponding to the various profile categories in the various social networking sites. As shown, for example, the presence of the Facebook, LinkedIn and MySpace icons within cell 422 indicates that the “Real Name” profile of the respective sites is presently set to “Public” status.

In one embodiment, the user might modify the reported privacy settings in the manner described in relation to FIG. 4, by either selecting privacy options from the drop-down menus 412-420 or by dragging and dropping icons from one cell to another in the arrangement of cells 422-450.

FIGS. 1-5 and the foregoing description depict specific exemplary embodiments of the invention to teach those skilled in the art how to make and use the invention. The described embodiments are to be considered in all respects only as illustrative and not restrictive. The present invention may be embodied in other specific forms without departing from the scope of the invention which is indicated by the appended claims. All changes that come within the meaning and range of equivalency of the claims are to be embraced within their scope.

For example, the term “social networking sites” as used herein is generally defined as any web-based platform in which persons may interact and share media content with other users, friends or the like and which the information about the user may be accessible to other users according to privacy settings. The present invention has been described with reference to particular social networking sites Facebook, LinkedIn, Twitter and MySpace but is not so limited to use with those sites.

The term “privacy settings” as used herein is generally defined as any scheme established by respective social networking sites for classifying or identifying user content, including profile information or posted content, for purposes of determining which users or user groups of the respective sites are eligible to access or view the content. The present invention has been described with reference to particular privacy settings “Public,” “Friends” and “Private” but is not so limited to use with those privacy settings.

The term “application platform” as used herein is generally defined as any computer device or software application residing remotely from the host platform that executes an application program to perform some kind of activity or transaction with a user. The application platform may include, without limitation, web-based platforms, or platforms residing internal to the firewall of a business or government enterprise; and the activity or transaction may include, without limitation, banking or financial transactions, e-commerce, gaming, communications or social networking transactions.

It should be understood that the term “processor” as used herein is intended to include one or more processing devices, including a central processing unit (CPU) or other processing circuitry, including but not limited to one or more signal processors, one or more integrated circuits, and the like. Also, the term “memory” as used herein is intended to include memory associated with a processor or CPU, such as RAM, ROM, a fixed memory device (e.g., hard drive), or a removable memory device (e.g., diskette or CDROM).

The term “graphical user interface” is generally defined as any user interface that allows users to view information through graphical icons, windows and/or other visual indicators via user platforms (including, without limitation, computer platforms and mobile communication devices) and in which the user may perform activities or transactions by interacting with the graphical images. The present invention has been described with reference to particular displays including graphical icons and cells for reporting or modifying privacy settings and particular manners of interacting with the images but is not so limited to use with those particular graphical icons and cells or the described manner of interacting with the graphical images. Rather, it should be understood that the present invention may be implemented using any type of graphical images and/or manner of interacting with the graphical images either presently known or devised in the future.

1. Apparatus for providing privacy management services associated with one or more social networking sites of a user, in accordance with a communication system including a user platform operably connected to an application platform, the apparatus at the application platform comprising:
a memory; and
at least one processor coupled to the memory and configured to:
access one or more social networking sites of a user;
obtain from the one or more social networking sites, indicia of privacy settings of the user corresponding to the respective social networking sites;
display the privacy settings on a graphical user interface accessible to the user independent of the social networking sites.

2. The apparatus of claim 1, wherein the processor is further configured to:
obtain from the user via the graphical user interface, indicia of one or more user changes to the privacy settings, the one or more user changes being associated with the privacy settings of at least one impacted site; and
interact with the at least one impacted site on behalf of the user to update the privacy settings.

3. The apparatus of claim 1, wherein the processor is further configured to:
obtain from one or more of the social networking sites, indicia of one or more site-initiated changes to the privacy settings; and
display the site-initiated changes on the graphical user interface, thereby enabling the user to view the site-initiated changes independent of the social networking sites.

4. A method for providing privacy management services associated with one or more social networking sites of a user, in accordance with a communication system including a user platform operably connected to an application platform, the method comprising the application platform:
obtaining from the one or more social networking sites, indicia of privacy settings of the user corresponding to the respective social networking sites;
displaying the privacy settings on a graphical user interface accessible to the user independent of the social networking sites.

5. The method of claim 4, further comprising:
obtaining from the user via the graphical user interface, indicia of one or more user changes to the privacy settings, the one or more user changes being associated with the privacy settings of at least one impacted site; and
interacting with the at least one impacted site on behalf of the user to update the privacy settings.

6. The method of claim 4, further comprising:
obtaining from one or more of the social networking sites, indicia of one or more site-initiated changes to the privacy settings; and
displaying the site-initiated changes on the graphical user interface, thereby enabling the user to view the site-initiated changes independent of the social networking sites.

7. An article of manufacture comprising a processor-readable storage medium storing one or more software programs which when executed by a processor associated with the application platform perform the steps of the method of claim 4.

8. Apparatus for providing privacy management services associated with one or more social networking sites of a user, in accordance with a communication system including a user platform operably connected to an application platform, the apparatus at the user platform comprising:
a memory;
a display comprising a graphical user interface; and
at least one processor coupled to the memory and display and configured to:
obtain from the application platform, indicia of privacy settings of the user corresponding to the respective social networking sites;
display the privacy settings to the user via a graphical user interface;
receive via the graphical user interface, indicia of one or more user changes to the privacy settings, the one or more user changes being associated with the privacy settings of at least one impacted site; and
communicate the user changes to the at least one impacted site via the application platform.

9. A method for providing privacy management services associated with one or more social networking sites of a user, in accordance with a communication system including a user platform operably connected to an application platform, the method comprising the user platform:
obtaining from the application platform, indicia of privacy settings of the user corresponding to the respective social networking sites;
displaying the privacy settings to the user via a graphical user interface;
receiving via the graphical user interface, indicia of one or more user changes to the privacy settings, the one or more user changes being associated with the privacy settings of at least one impacted site; and
communicating the user changes to the at least one impacted site via the application platform.

10. An article of manufacture comprising a processor-readable storage medium storing one or more software programs which when executed by a processor associated with the user platform perform the steps of the method of claim 9.
